(19) United States
(12) Patent Application Publication
(10) Pub. No.: US 2026/0035819 A1
(43) Pub. Date: Feb. 5, 2026

(54) SYSTEMS AND METHODS TO MANAGE HYDROGEN CONCENTRATION WITHIN OXYGEN PRODUCT GAS IN AN ELECTROLYSIS SYSTEM

(71) Applicant: New Hydrogen IP, LLC, Columbus, IN (US)

(72) Inventor: Richard J. Ancimer, Toronto (CA)

(21) Appl. No.: 18/793,260

(22) Filed: Aug. 2, 2024

(51) Int. Cl. C25B 15/08; B01D 53/22; C25B 1/04; C25B 9/77; C25B 15/025

(52) U.S. Cl. CPC C25B 15/083; B01D 53/22; C25B 1/04; C25B 9/77; C25B 15/025; C25B 15/085; B01D 2053/221; B01D 2256/12; B01D 2257/108

(57) ABSTRACT

An electrolysis system includes an electrolyzer cell stack, a water tank, and a hydrogen management system. The electrolyzer cell stack uses water and electricity to produce a hydrogen product gas and an oxygen product gas including crossover hydrogen gas. The water tank is configured to receive a hydrogen tank stream including water and dissolved hydrogen gas and an oxygen tank stream including water and dissolved oxygen gas. In the water tank, the dissolved hydrogen gas and the dissolved oxygen gas exsolve from the water to form a gas mixture. The hydrogen management system is configured to control a concentration of the crossover hydrogen gas in at least a portion of the oxygen product gas to form a diluent for introduction into the water tank to decrease a hydrogen gas concentration in the gas mixture of the water tank.

### TECHNICAL FIELD

The present disclosure relates to a hydrogen management system for use in an electrolysis system and methods of using the hydrogen management system.

### SUMMARY

Embodiments of the present disclosure are included to meet these and other needs.

In one aspect, described herein an electrolysis system includes an electrolyzer cell stack, a water tank, and a hydrogen management system. The electrolyzer cell stack is configured to use water and electricity to produce a hydrogen product gas and an oxygen product gas. The oxygen product gas is configured to include crossover hydrogen gas. The water tank is arranged downstream of the electrolyzer cell stack and configured to receive a hydrogen tank stream including a first portion of water and dissolved or entrained hydrogen gas therein and an oxygen tank stream including a second portion of water and dissolved or entrained oxygen gas therein. In the water tank, the dissolved or entrained hydrogen gas and the dissolved or entrained oxygen gas exsolve from the first and second portions of water to form a gas mixture. The hydrogen management system is configured to control a concentration of the crossover hydrogen gas in at least a portion of the oxygen product gas to form a diluent for introduction into the water tank to decrease a hydrogen gas concentration in the gas mixture of the water tank to be at or below a threshold value.

In some embodiments, the hydrogen management system may include a controller configured to determine a volume fraction of the crossover hydrogen gas in the at least a portion of the oxygen product gas, and based at least in part on the volume fraction of the crossover hydrogen gas in the at least a portion of the oxygen product gas, the control system may be configured to determine a reference volume fraction.

In some embodiments, in response to the reference volume fraction being greater than a first threshold value, a minimum operating production load may be set by the controller to control the concentration of the crossover hydrogen gas in the at least a portion of the oxygen product gas that forms the diluent and the controller may operate the electrolyzer cell stack at or above the minimum operating production load.

In some embodiments, in response to the reference volume fraction being less than the first threshold value and greater than a zero threshold value, the diluent may be introduced into the water tank at a first flow rate and the controller may output a warning.

In some embodiments, in response to the reference volume fraction being less than the zero threshold value, the diluent may be introduced into the water tank at a second flow rate. In some embodiments, the second flow rate may be less than the first flow rate.

In some embodiments, in response to the reference volume fraction being greater than a second threshold value, the electrolyzer cell stack may be shut down and the diluent may not be introduced into the water tank. In some embodiments, the second threshold value may be greater than the first threshold value.

In some embodiments, the diluent may be a first diluent and the hydrogen management system may further control a second diluent different than the first diluent. In some embodiments, the second diluent and the first diluent may both be introduced into the water tank to decrease the hydrogen gas concentration in the gas mixture of the water tank.

In some embodiments, the hydrogen management system may include a controller configured to determine a minimum operating production load of the electrolyzer cell stack. In some embodiments, the controller may operate the electrolyzer cell stack at or above the minimum operating production load to control the concentration of the crossover hydrogen gas in the at least a portion of the oxygen product stream that forms first diluent.

In some embodiments, the hydrogen management system may include a catalyst arranged between the electrolyzer cell stack and the water tank. In some embodiments, the catalyst may be configured to remove at least a portion of the crossover hydrogen gas from the at least a portion of the oxygen product gas to decrease the concentration of the crossover hydrogen gas and form a purified oxygen product gas for introduction into the water tank as the diluent.

In some embodiments, the hydrogen management system may further include a dryer arranged upstream of the catalyst and configured to remove moisture from the at least a portion of the oxygen product gas prior to the at least a portion of the oxygen product gas being exposed to the catalyst. In some embodiments, the hydrogen management system may further include a heat exchanger arranged downstream of the catalyst and configured to cool the purified oxygen product gas prior to introduction into the water tank.

In some embodiments, the hydrogen management system may include a gas membrane separator having a membrane. In some embodiments, the gas membrane separator may be arranged between the electrolyzer cell stack and the water tank and may be configured to receive the at least a portion of the oxygen product gas therein. In some embodiments, the membrane may be configured to diffuse the crossover hydrogen gas therethrough to decrease the concentration of the crossover hydrogen gas in the at least a portion of the oxygen product gas and form a purified oxygen product stream for introduction into the water tank as the diluent. In some embodiments, the membrane may be configured to diffuse the crossover hydrogen gas therethrough to a sweep side. In some embodiments, a sweep fluid may be directed through the sweep side to decrease a concentration of the crossover hydrogen gas on the sweep side.

In a second aspect, described herein, a method of operating an electrolysis system is provided. The method includes producing a hydrogen product gas and an oxygen product gas by an electrolyzer cell stack. The oxygen product gas is configured to include crossover hydrogen gas therein. The method includes exsolving hydrogen gas and oxygen gas in a water tank located downstream of the electrolyzer cell stack to form a gas mixture. The method includes managing a concentration of the crossover hydrogen gas in at least a portion of the oxygen product gas to form a diluent. The method includes injecting the diluent into the water tank to decrease a hydrogen gas concentration of the gas mixture in the water tank.

In some embodiments, the method may include measuring a volume fraction of the crossover hydrogen gas in the oxygen product gas and determining, via a controller, a reference volume fraction based on the volume fraction. In some embodiments, the method may include comparing the reference volume fraction to a threshold value, and in response to the reference volume fraction being greater than the threshold value, setting a minimum operating production load of the electrolyzer cell stack via the controller such that the electrolyzer cell stack operates at or above the minimum operating production load.

In some embodiments, the method may include, in response to the reference volume fraction being greater than a zero threshold value and less than the threshold value, outputting a warning and increasing a flow rate of the diluent into the water tank.

In some embodiments, the method may include directing the at least a portion of the oxygen product gas into a catalyst arranged downstream of the electrolyzer cell stack to remove at least a portion of the crossover hydrogen gas from the at least a portion of the oxygen product gas to form the diluent.

In some embodiments, the method may include directing the at least a portion of the oxygen product gas into a gas membrane separator arranged downstream of the electrolyzer cell stack to separate the crossover hydrogen gas from the at least a portion of the oxygen product gas to form the diluent.

### BRIEF DESCRIPTION OF THE DRAWINGS

FIG. 1A is perspective view of an electrolyzer cell stack according to the present disclosure;

FIG. 1B is a schematic view of an electrolysis system configured to utilize the electrolyzer cell stack of FIG. 1A and including a hydrogen management system;

FIG. 1C is a schematic view of an additional portion of the electrolysis system of FIG. 1B;

FIG. 2 is a graph showing a relationship between the volume fraction of hydrogen in oxygen (HTO) of an oxygen product gas of the electrolyzer cell stack of FIG. 1A and a production load of the electrolyzer cell stack of FIG. 1A;

FIG. 3A is a schematic view of a water tank of the electrolysis system of FIG. 1C showing a formation of a mixture of hydrogen gas and oxygen gas above liquid water in the water tank, and further showing that a diluent formed from the oxygen product gas is injected into the water tank to decrease a hydrogen concentration in the mixture to prevent the formation of a flammable mixture in the water tank;

FIG. 3B is a process diagram of the electrolysis system;

FIG. 4 is a graph showing a relationship between a maximum HTO of the oxygen product gas and the production load of the electrolyzer cell stack, and further showing that the maximum HTO of the oxygen product gas decreases as the production load increases;

FIG. 5 is a schematic view of a control system included in the hydrogen management system of FIG. 1B, the control system configured to manage the HTO of the oxygen product gas so that the oxygen product gas forms the diluent for the water tank;

FIG. 6 is a schematic view of an alternate hydrogen management system for use in the electrolysis system of FIGS. 1B and 1C, the hydrogen management system includes a catalyst configured to remove hydrogen gas from the oxygen product gas to decrease the HTO of the oxygen product gas so that the oxygen product gas forms the diluent for the water tank;

FIG. 7 is a schematic view of an alternate hydrogen management system for use in the electrolysis system of FIGS. 1B and 1C, the hydrogen management system includes a gas membrane separator configured to separate hydrogen gas from oxygen gas of the oxygen product gas to decrease the HTO of the oxygen product gas so that the oxygen product gas forms the diluent for the water tank;

FIG. 8 is a graph showing a relationship between a mass flow rate of the oxygen product gas as the diluent and the production load of the electrolyzer cell stack, and further showing that the mass flow rate of the diluent increases as the production load increases;

FIG. 9 is a graph showing a relationship between a fraction of the available oxygen product gas used as the diluent and the production load of the electrolyzer cell stack;

FIG. 10 is a graph showing a relationship between a mass flow rate of the oxygen product gas feed flow and a sweep flow through the gas membrane separator of FIG. 7 and the production load of the electrolyzer cell stack, and further showing that the mass flow rate of the oxygen product gas feed flow increases as the production load increases; and

FIG. 11 is a graph showing a relationship between a mass flow rate of the oxygen product gas feed flow and the sweep flow through the gas membrane separator of FIG. 7 and the production load of the electrolyzer cell stack, and further showing that the mass flow rate of the oxygen product gas feed flow increases as the gas membrane separator ages and degrades, and the mass flow rate of the sweep flow decreases as the gas membrane separator ages and degrades.

### DETAILED DESCRIPTION

Electrolysis systems use water and electricity to produce hydrogen and oxygen. Electrolysis systems can be prone to forming flammable mixtures in various water tanks of the electrolysis systems. For example, some water tanks of the electrolysis systems include water therein containing dissolved hydrogen gas and dissolved oxygen gas. The water in these water tanks exsolves both hydrogen gas and oxygen gas, which may result in a flammable mixture forming in the water tanks. To prevent the formation of a flammable mixture, a diluent can be introduced into the water tanks to maintain a hydrogen concentration below a fraction of a lower flammability limit. Common diluents include nitrogen gas and air. However, such diluents require additional components, such as filters, blowers, compressors, and/or nitrogen separators, and are expensive to implement. Thus, it would be advantageous to provide a more efficient diluent for electrolysis systems.

The present disclosure is directed to a hydrogen management system for use in an electrolysis system and methods of using the hydrogen management system to provide a diluent for the electrolysis system.

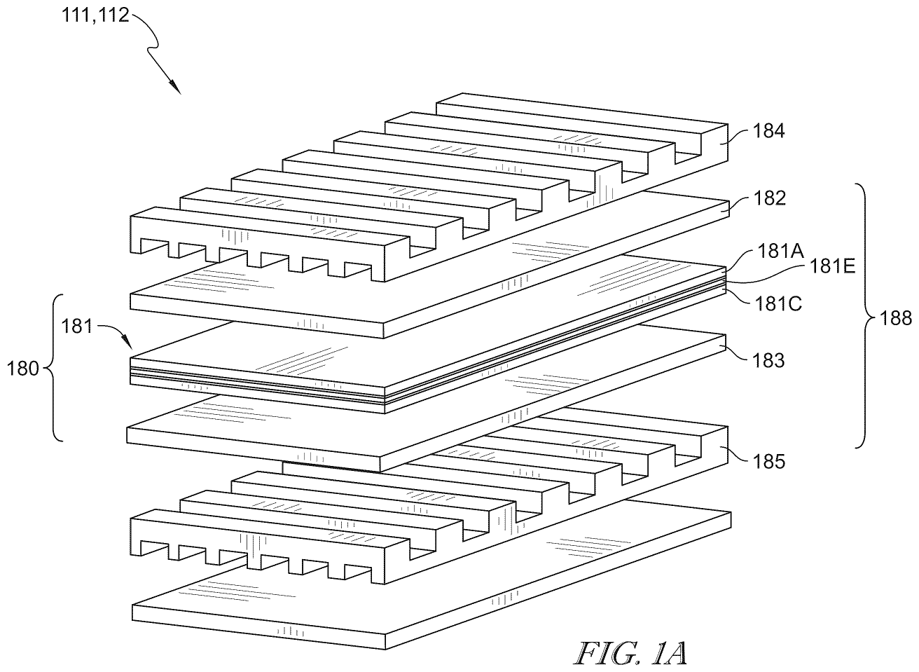

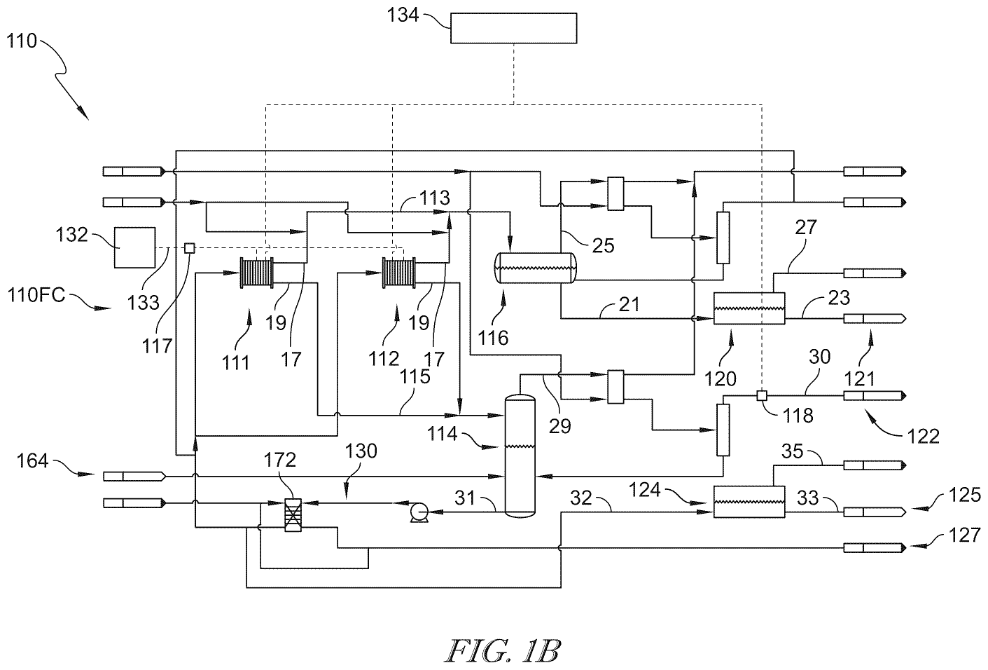

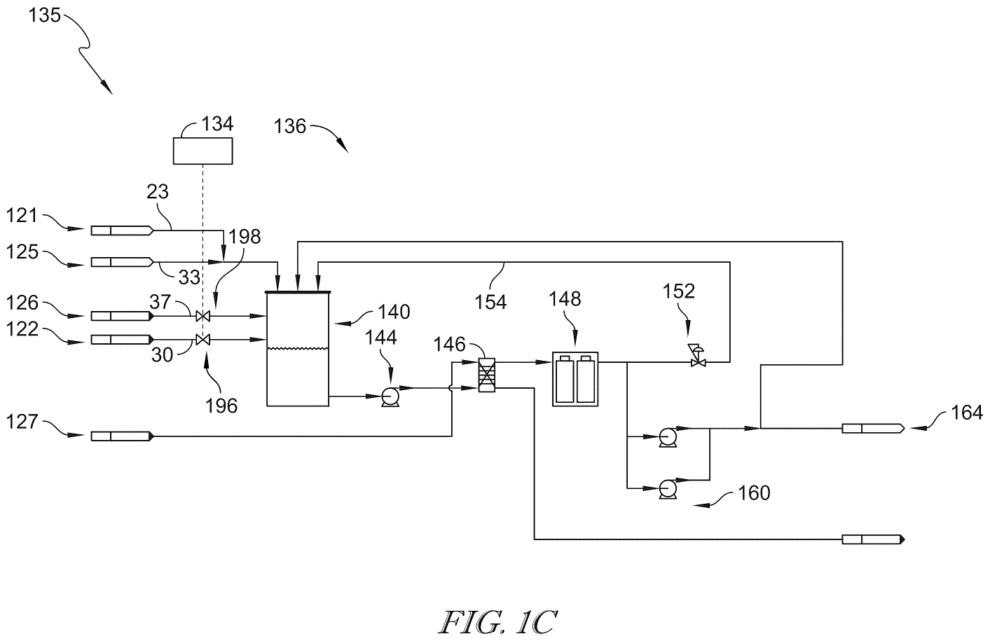

FIG. 1B illustrates an electrolysis system 110 that is configured to produce hydrogen and oxygen from water and electricity. Electrolysis systems, like the electrolysis system 110, typically include one or more electrolyzer cells 180, as shown in FIG. 1A, that utilize electricity to chemically produce hydrogen and oxygen from water, such as deionized water 130 (shown in FIG. 1B). The electrical source for the electrolysis systems 110 can be produced from power or energy generation systems, including renewable energy systems such as wind, solar, hydroelectric, and geothermal sources for the production of green hydrogen. In turn, hydrogen produced by the electrolysis systems 110 can be utilized as a fuel or energy source for those same power generation systems, such as fuel cell systems, or can be used to produce other products such as ammonia. The hydrogen produced by the electrolysis systems 110 may be stored for later use.

The typical electrolytic or electrolyzer cell, such as the electrolytic cell 180 includes multiple assemblies compressed and bound into a single assembly. Multiple electrolyzer cells 180 may be stacked relative to each other, along with bipolar plates (BPP) 184, 185 therebetween, to form an electrolyzer cell stack (for example, electrolyzer cell stacks 111, 112 in FIGS. 1A and 1B). Each electrolyzer cell stack 111, 112 may house a plurality of electrolyzer cells 180 connected together in series and/or in parallel. The number of electrolyzer cell stacks 111, 112 in the electrolysis systems 110 can vary depending on the amount of power required to meet the power need of any load (e.g., fuel cell stack). The number of electrolyzer cells 180 in an electrolyzer cell stack 111, 112 can be tailored, for example, to produce a desired amount of hydrogen or based on the amount of power required to operate the electrolysis systems 110 including the electrolyzer cell stack 111, 112.

The electrolyzer cell 180 in FIG. 1A includes a multi-component membrane electrode assembly (MEA) 181 that has an electrolyte 181E, an anode 181A, and a cathode 181C. Typically, the anode 181A, cathode 181C, and electrolyte 181E of the MEA 181 are configured in a multi-layer arrangement that enables the electrochemical reaction to produce hydrogen and/or oxygen via contact of the water with one or more gas diffusion layers (GDLs) 182, 183. Each GDL 182, 183 may also be referred to as porous transport layer (PTL), and are typically located on one or both sides of the MEA 181. Bipolar plates (BPP) 184, 185 often reside on either side of the GDLs 182, 183 and separate the individual electrolyzer cells 180 of the electrolyzer cell stack 111, 112 from one another. One bipolar plate 185 and the adjacent gas diffusion layers 182, 183 and MEA 181 can form a repeating unit 188, which can be stacked on top of other units 188 to form a cell stack 111, 112.

FIG. 1B illustrates an exemplary electrolysis system 110 including two electrolyzer cell stacks 111, 112 and a fluidic circuit 110FC, which includes the various fluidic pathways shown in FIGS. 1B and 1C to circulate, inject, and purge fluid and other components to and from the electrolysis systems 110. One or a variety of a number of components within the fluidic circuit 110FC, as well as more or less than two electrolyzer cell stacks 111, 112, may be utilized in the electrolysis systems 110. For example, the electrolysis systems 110 may include one electrolyzer cell stack 111, and in other examples, the electrolysis systems 110 may include three or more electrolyzer cell stacks.

Each electrolysis system 110 may include one or more types of electrolyzer cell stacks 111, 112 therein. In the illustrated embodiment, a polymer electrolyte membrane (PEM) electrolyzer cell 180 may be utilized in the stacks 111, 112. By way of example, the PEM electrolyzer cell can operate at about 4° C. to about 150° C., including any specific or range of temperatures comprised therein; and can function at about 100 bar or less, but can go up to about 1000 bar (including any specific or range of pressures comprised therein), such as to reduce the total energy demand of the system. A standard electrochemical reaction that occurs in a PEM electrolyzer cell 180 to produce hydrogen is as follows.

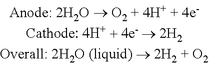

Also, for example, a solid oxide electrolyzer cell may be utilized in the electrolysis system(s) 110, such as where the solid oxide electrolyzer cell functions at about 500° C. to about 1000° C., including any specific or range of temperatures comprised therein. A standard electrochemical reaction that occurs in a solid oxide electrolyzer cell 180 to produce hydrogen is as follows.

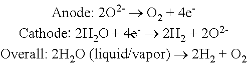

Yet another example, an anion exchange membrane (AEM) electrolyzer cell may be utilized, which may use an alkaline media. An alkaline AEM electrolyzer cell can include aqueous solutions, such as potassium hydroxide (KOH) and/or sodium hydroxide (NaOH), as the electrolyte; can perform at operating temperatures ranging from about 0° C. to about 150° C., including any specific or range of temperatures comprised therein; and can operate at pressures ranging from about 1 bar to about 100 bar, including any specific or range of pressures comprised therein. A standard hydrogen-generating electrochemical reaction that occurs in an alkaline electrolyzer cell 180 is as follows.

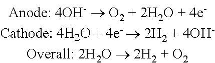

The electrolyzer cell stacks 111, 112 of FIG. 1B can include one or more electrolyzer cells 180 that utilize electricity to chemically produce substantially pure hydrogen and oxygen from water. In turn, the pure hydrogen produced by the electrolyzer cells 180 may be utilized, for example, as a fuel or energy source, or to produce other products such as ammonia.

Each electrolyzer cell stack 111, 112 outputs a hydrogen stack stream 17 (i.e., the produced hydrogen which may contain some water therein) into a fluidic connecting line 113 in fluid connection with a hydrogen separator 116. Each electrolyzer cell stack 111, 112 also outputs an oxygen stack stream 19 (i.e., the produced oxygen which may contain some water therein) into a fluidic connecting line 115 in fluid connection with an oxygen separator 114.

The hydrogen separator 116 separates hydrogen gas from the hydrogen stack stream 17 and outputs the separated hydrogen gas to a hydrogen gas line 25, while also sending additional output fluid (i.e., a hydrogen separator stream 21) to a hydrogen drain tank 120. The hydrogen separator 116 operates at a high pressure (for example, 30 bar or more), such that some hydrogen gas may dissolve in the hydrogen separator stream 21 being produced by the hydrogen separator 116. There may also be entrained hydrogen gas within the hydrogen separator stream 21 due to inefficiency of the hydrogen separator 116.

Entrained hydrogen gas refers to hydrogen gas bubbles that remain in the hydrogen separator stream 21 (i.e., hydrogen gas that was not separated out from the hydrogen stack stream 17 in the hydrogen separator 116). Dissolved hydrogen gas refers to hydrogen gas molecules in the water solution (the hydrogen separator stream 21). The amount of hydrogen gas that is dissolved in the hydrogen separator stream 21 depends on a pressure and a temperature within the hydrogen separator 116. The higher the pressure, the more hydrogen gas is dissolved in the hydrogen separator stream 21. The hydrogen drain tank 120 operates at a lower pressure than the hydrogen separator 116 (for example, about atmospheric pressure, which is about 1.01 bar).

The hydrogen drain tank 120 receives the hydrogen separator stream 21 (i.e., water with dissolved and/or entrained hydrogen gas therein) from the hydrogen separator 116, as shown in FIG. 1B. The hydrogen drain tank 120 outputs a hydrogen tank stream 23 to a deionized water drain 121. The hydrogen drain tank 120 degasses at least a portion of the hydrogen gas 27 from the hydrogen separator stream 21. The hydrogen gas 27 can then be vented from the hydrogen drain tank 120. The hydrogen tank stream 23 (i.e., water with residual hydrogen gas) is directed to the deionized water drain 121 and then the deionized water tank 140, as shown in FIGS. 1B and IC.

The oxygen separator 114 receives the oxygen stack stream 19 from the electrolyzer cell stack 111, 112, as shown in FIG. 1B. The oxygen separator 114 separates oxygen gas (i.e., an oxygen product gas 29) from the oxygen stack stream 19. The oxygen separator 114 outputs oxygen product gas 29, while also sending additional output fluid (i.e., an oxygen separator stream 31) to an oxygen drain tank 124. The oxygen separator 114 operates at a high pressure (for example, 30 bar or more), such that oxygen gas may dissolve in the oxygen separator stream 31 being produced by the oxygen separator 114. There may also be entrained oxygen gas within the oxygen separator stream 31 due to inefficiency of the oxygen separator 114. The amount of oxygen gas that is dissolved in the oxygen separator stream 31 depends on a pressure and a temperature within the oxygen separator 114. The higher the pressure, the more oxygen gas is dissolved in the oxygen separator stream 31. The oxygen drain tank 124 operates at a lower pressure than the oxygen separator 114 (for example, about atmospheric pressure, which is about 1.01 bar).

A portion of the oxygen product gas 29 output from the oxygen separator 114 is directed to an oxygen gas input 122 as a diluent 30 and then into the deionized water tank 140, as shown in FIGS. 1B and 1C. The remaining portion of the oxygen product gas 29 output from the oxygen separator 114 is not directed toward the deionized water tank 140, and instead remains as the oxygen product gas 29 of the electrolysis system 110. The oxygen drain tank 124 receives a portion 32 of the oxygen separator stream 31 (i.e., water with dissolved and/or entrained oxygen gas therein) from the oxygen separator 114, as shown in FIG. 1B. The oxygen drain tank 124 outputs an oxygen tank stream 33 to a deionized water drain 125. The oxygen drain tank 124 degasses at least a portion of the oxygen gas 35 from the portion 32 of the oxygen separator stream 31.

The oxygen gas 35 can then be vented out of the hydrogen drain tank 124 to a separate oxygen collection tank (not shown) and/or to atmosphere. The oxygen tank stream 33 (i.e., water with residual oxygen gas) is directed to the deionized water drain 125 and then the deionized water tank 140, as shown in FIGS. 1B and 1C. Alternatively, the portion 32 of the oxygen separator stream 31 can be directed directly to the deionized water drain 125 bypassing the oxygen drain tank 124. The portion 32 of the oxygen separator stream 31 can then degas within the deionized water tank 140.

Certain inputs and outputs of fluid may be pure water or other fluids such as coolant or byproducts of the chemical reactions of the electrolyzer cell stacks 111, 112. For example, oxygen and hydrogen may flow away from the cell stacks 111, 112 to the respective separators 114, 116.

The electrolysis system 110 is shown in FIG. 1B to include a rectifier 132 configured to convert electricity 133 flowing to the cell stacks 111, 112 from alternating current (AC) to direct current (DC).

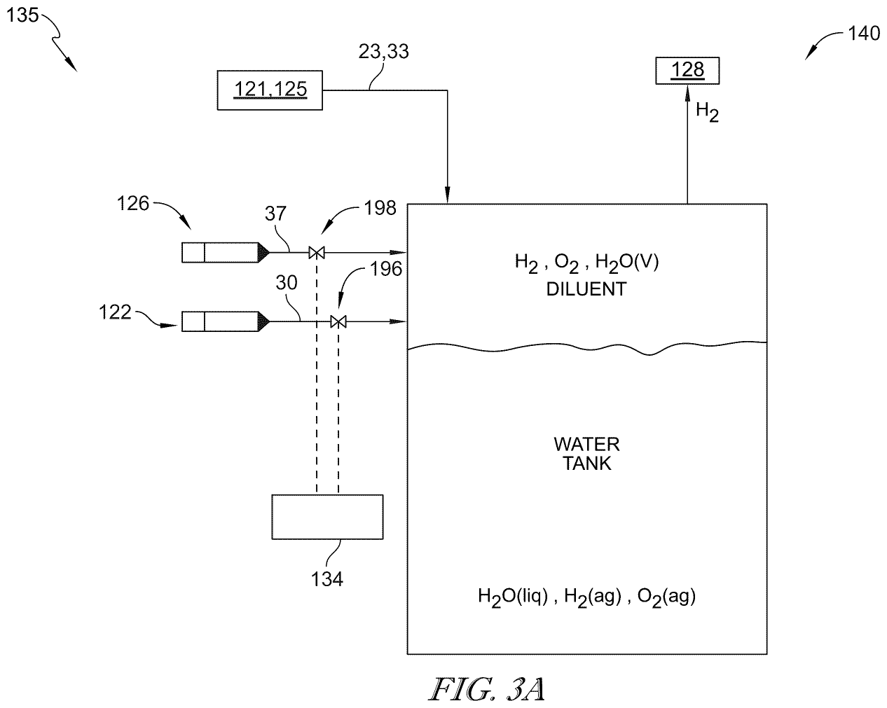

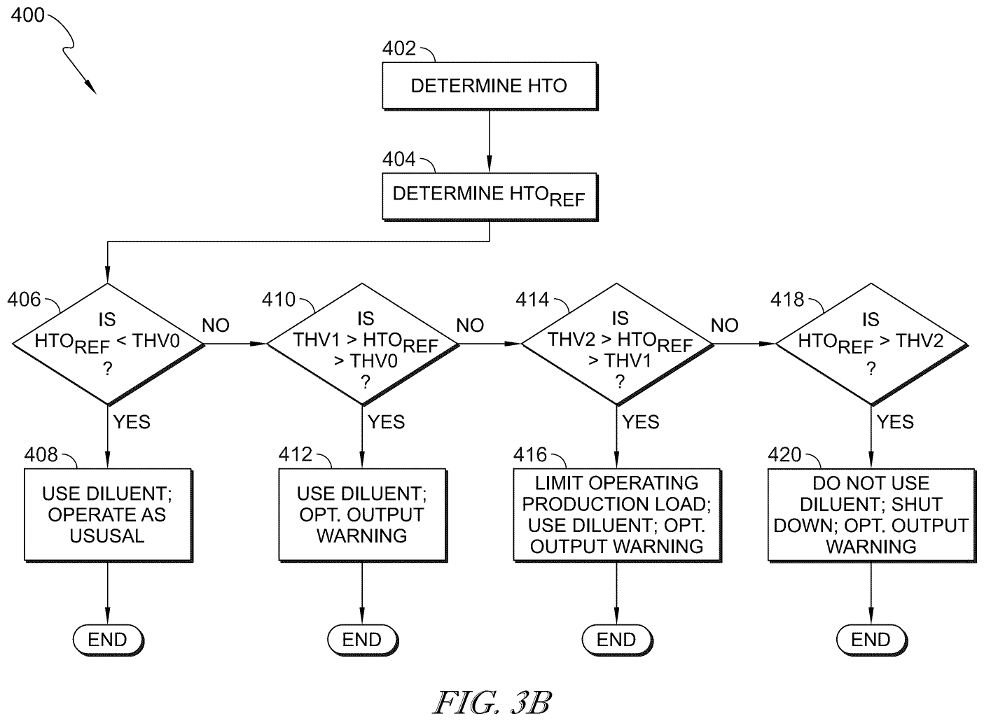

The deionized water drains 121, 125 shown in shown in FIGS. 1B and IC output the hydrogen tank stream 23 and the oxygen tank stream 33, respectively, to the deionized water tank 140, which is part of a polishing loop 136 (FIG. 1B) of the fluidic circuit 110FC (FIG. 1C). The deionized water tank 140 contains water from two sources: (i) the hydrogen drain tank 120 which provides water having hydrogen gas dissolved therein; and (ii) the oxygen drain tank 124 which provides water having oxygen gas dissolved therein. The deionized water tank 140, thus, includes hydrogen gas and oxygen gas that are both degassing from the water such that a hydrogen and oxygen gas mixture is being formed above the liquid water in the deionized water tank 140, as shown in FIG. 3A. A flammable mixture of hydrogen gas and oxygen gas can form above the liquid water in the deionized water tank 140.

Generally, a hydrogen degassing rate in the deionized water tank 140 increases with an increase in production load of the stacks 111, 112 or the cell 180. The production load is the load or current density at which the cell 180 is being operated. An amount of the hydrogen tank stream 23 entering the deionized water tank 140 from the hydrogen drain tank 120 is proportional to the production load, meaning at higher production loads, a greater amount of the hydrogen tank stream 23 enters the deionized water tank 140. The concentration of dissolved hydrogen gas in the hydrogen tank stream 23 entering the deionized water tank 140 from the hydrogen drain tank 120 is similar across operational loads, if, for example, the hydrogen gas operating pressure and temperature are similar across the range of production loads.

However, as the production load increases, a residence time in the hydrogen separator 116 and the hydrogen drain tank 120 decreases as the hydrogen tank stream 23 flow rate is larger. As the residence time decreases, effectiveness of the hydrogen separator 116 and the hydrogen drain tank 120 decreases, which means more dissolved hydrogen gas enters the deionized water tank 140 in the hydrogen tank stream 23 (i.e., a hydrogen gas concentration in the hydrogen tank stream 23 is increased). The total amount of hydrogen gas entering the deionized water tank 140 is defined by a concentration of the hydrogen gas in the hydrogen tank stream 23 times a flow rate of the hydrogen tank stream 23 into the deionized water tank 140.

Thus, increasing the hydrogen gas concentration in the hydrogen tank stream 23 increases the total amount of hydrogen gas entering the deionized water tank 140. Additionally, increasing the flow rate of the hydrogen tank steam 23 into the deionized water tank 140 increases the total amount of hydrogen gas entering the deionized water tank 140.

The amount of the oxygen tank stream 33 entering the deionized water tank 140 from the oxygen drain tank 124 is approximately constant across production loads. Generally, the oxygen tank stream 33 works to control a cleanliness of the water output from the deionized water tank 140. Conductivity (a function of ion content) in the water increases over time as metals and/or other materials dissolve during operation of the electrolysis system 110. Water is fed to the deionized water tank 140 to be cleaned through the polishing loop 136, as discussed in more detail below.

In some embodiments, to help clean the water, the amount of the oxygen tank stream 33 entering the deionized water tank 140 is kept approximately constant across production loads. In alternative embodiments, to help clean the water, the amount of the oxygen tank stream 33 entering the deionized water tank 140 plus the amount of the hydrogen tank stream 23 entering the deionized water tank 140 is kept approximately constant across production loads.

In some embodiments, a proportion of the hydrogen tank stream 23 to the oxygen tank stream 33 entering the deionized water tank 140 is higher at higher production rates. Thus, the hydrogen gas concentration in the water of the deionized water tank 140 is higher at higher production rates. Therefore, the degassing rate of hydrogen gas in the deionized water tank 140 increases as the hydrogen gas concentration increases in the water of the deionized water tank 140. For example, in one electrolysis system, the hydrogen gas degassing rate was measured to be about 0.75 standard liters per minute (“slpm”) at about 100% production load and about 0.2 slpm at about 25% production load.

Turning back to the polishing loop 136, water with ion content can damage electrolyzer cell stacks 111, 112 when the ionized water interacts with internal components of the electrolyzer cell stacks 111, 112. The polishing loop 136, shown in greater detail in FIG. 1C, is configured to deionize the water such that it may be utilized without damaging the cell stacks 111, 112.

FIG. 1C illustrates that the deionized water tank 140 outputs fluid, in particular water, to a deionized water polishing pump 144, which in turn outputs the water to a water polishing heat exchanger 146 for polishing and treatment. The water then flows to a deionized water resin tank 148.

Coolant is directed through the electrolysis systems 110, in particular through a deionized water heat exchanger 172 that is fluidically connected to the oxygen separator 114, as shown in FIG. 1B. The coolant may also be subsequently fed to the water polishing heat exchanger 146 via a coolant input 127 for polishing. The coolant is then output back to the deionized water heat exchanger 172 for cooling the water therein.

After the water is output from the deionized water polishing heat exchanger 146 and subsequently to the deionized water resin tank 148, a portion of the water may be fed to deionized water high pressure feed pumps 160, as shown in FIG. 1C. Another portion of the water may be fed to a deionized water pressure control valve 152, as shown in FIG. 1C. The portion of the water that is fed to the deionized water pressure control valve 152 flows through a recirculation fluidic connection 154 that allows the water to flow back to the deionized water tank 140 for continued polishing.

In some embodiments, the electrolysis systems 110 may increase deionized water skid for polishing water flow to flush out ions within the water at a faster rate. The portion of the water that is fed to the deionized water high pressure feed pumps 160 is then output to a deionized water feed 164, which then flows into the oxygen separator 114 for recirculation and eventual reusage in the electrolyzer cell stacks 111, 112. This process may then continuously repeat.

The electrolysis systems 110 described herein have particular application for use in stationary (or immovable) power systems, such as industrial applications and power generation plants. The electrolysis systems 110 may also be implemented in conjunction with other electrolysis systems 110.

The present electrolysis systems 110 may be comprised in stationary or mobile applications. The electrolysis systems 110 may be in the vehicle or a powertrain. The vehicle or powertrain comprising the electrolysis systems 110 may be an automobile, a pass car, a bus, a truck, a train, a locomotive, an aircraft, a light duty vehicle, a medium duty vehicle, or a heavy duty vehicle.

Generally, in the electrolyzer cell 180 of FIG. 1A, a portion of the hydrogen gas being produced by the cell 180 crosses over and/or diffuses through the electrolyte 181E. A volume fraction of hydrogen in oxygen (HTO) represents the concentration of hydrogen gas in the oxygen gas due to crossover. The terms volume fraction, HTO, and mole fraction may be used interchangeably. The higher a hydrogen partial pressure on the cathode 181C side of the cell 180, the higher a diffusion rate of hydrogen gas through the electrolyte 181E. In other words, the higher an operating pressure of the cell 180, the higher a driving force for the hydrogen gas to diffuse through the porous electrolyte 181E. The diffusion rate of the hydrogen gas also depends on thickness and material type of the electrolyte 181E. The thinner the electrolyte 181E, the higher the diffusion rate of the hydrogen gas. As the cell 180 ages, the electrolyte 181E thins over time. Further, electrolytes 181E are prone to forming pinholes over time, which increases a net hydrogen gas crossover.

In some embodiments, a recombination catalyst (not shown) is arranged near the anode 181A side of the cell 180 to recombine the hydrogen gas that crosses over the electrolyte 181E and the oxygen gas to create water. Thus, the recombination catalyst helps to manage the HTO. However, recombination catalysts decay over time. Thus, as the cell 180 ages, the rate of hydrogen gas crossover increases (i.e., the HTO increases).

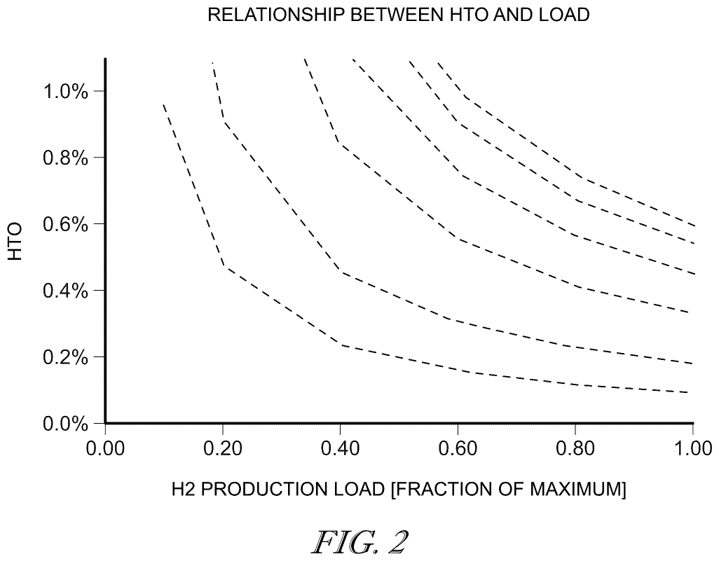

The rate of hydrogen gas crossover is approximately constant throughout the operating cycle of the cell 180. In other words, the rate of hydrogen gas crossover generally does not vary as the production load varies. When the production load is increased, more oxygen gas is produced by the cell 180. Because the rate of hydrogen gas crossover is generally constant, the HTO follows an exponential decay curve as the production load is increased, as shown in FIG. 2.

In general, the HTO decreases as the production load of the cell 180 increases because a net hydrogen gas crossover variation across production load is substantially smaller than the increase in the oxygen gas production rate at higher production loads. For example, if 1 mol of hydrogen gas crosses over the electrolyte 181E, and the cell 180 produces 10 mol of oxygen gas, then the HTO is 10%. As another example, if 1 mol of hydrogen gas crosses over the electrolyte 181E, and the cell 180 produces 100 mol of oxygen gas, then the HTO is 1%. Thus, the HTO varies with a production load and an age of the cell 180. Specifically, the HTO tends to increase at lower loads and the HTO tends to increase with an age of the cell 180.

The HTO is measured by an HTO sensor 118, which, as shown in FIG. 1B, is arranged downstream of the oxygen separator 114. Illustratively, the HTO sensor calculates and/or determines the hydrogen gas concentration in the oxygen product gas 29 and/or in the diluent 30. In some embodiments, the HTO sensor 118 is arranged downstream of each stack 111, 112 to determine the HTO related to each stack 111, 112.

As previously described, a flammable hydrogen and oxygen gas mixture is prone to formation above the water in the deionized water tank 140, as shown in FIG. 3A. To manage the flammable mixture forming above the water in the deionized water tank 140, a diluent may be added to the deionized water tank 140 to dilute the hydrogen gas of the mixture below its flammability level. The diluent is used to maintain a hydrogen gas concentration within the mixture below a fraction of a lower flammability limit.

Above 4% hydrogen in the mixture is considered flammable and therefore a maximum of about 2% hydrogen is an agreed upon standard in the International Standard on hydrogen production using water electrolysis. In some embodiments, the lower flammability limit is about 4% hydrogen. In some embodiments, the lower flammability limit is about 2% hydrogen. In some embodiments, the diluent maintains the hydrogen gas concentration within the mixture to be about 2% hydrogen or less than about 2% hydrogen. A particular amount of diluent is required to maintain the hydrogen gas concentration to be about 2% hydrogen or less than about 2% hydrogen. This particular amount of diluent is dependent, at least in part, on the hydrogen gas concentration in the oxygen product gas 29.

Nitrogen gas is an example of a diluent for use in the electrolysis systems. However, nitrogen gas is costly and requires additional equipment. Air is another example of a diluent for use in the electrolysis systems. However, air requires cleaning and filtration prior to use as a diluent, such as within a deionized water tank (e.g., the deionized water tank 140).

A portion of or all the oxygen product gas 29 within the oxygen gas input 122 can be used as a diluent 30 in the electrolysis system 110. However, the HTO of the oxygen product gas 29 introduces difficulty for using the portion of the oxygen product gas 29 as the diluent 30.

The present disclosure provides, among other aspects, a hydrogen management system 135 including a control system 134 (e.g., a controller) configured to manage hydrogen gas content within the portion of the oxygen product gas 29 so that at least a portion of the oxygen product gas 29 can be used as the diluent 30 for the deionized water tank 140. Injecting the portion of the oxygen product gas 29 as the diluent 30 into the deionized water tank 140 causes some hydrogen gas to be injected into the deionized water tank 140 due to the hydrogen gas crossover within the cell 180. In other words, more diluent 30 is required to dilute the mixture in the deionized water tank 140 as compared to injecting pure oxygen gas containing no hydrogen gas therein.

The HTO impacts the ability for the portion of the oxygen product gas 29 to dilute the hydrogen gas within the mixture in the deionized water tank 140 below the target hydrogen concentration of about 2%. Thus, the hydrogen management system 135 manages the hydrogen gas content within the portion of the oxygen product gas 29 so that the portion of the oxygen product gas 29 can be used as the diluent 30 for the deionized water tank 140 to maintain the hydrogen therein at or below a threshold, such as the lower flammability limit, to prevent the formation of a flammable mixture in the deionized water tank 140.

In some embodiments, the dilution target is to maintain the hydrogen concentration in the mixture within the deionized water tank 140 to be less than about 2% hydrogen. If the HTO within the portion of the oxygen product gas 29 (i.e., the diluent 30) is about 2% hydrogen, then the portion of the oxygen product gas 29 cannot dilute the mixture within the deionized water tank 140 below 2% hydrogen. If the HTO within the portion of the oxygen product gas 29 is about 1% hydrogen, then the portion of the oxygen product gas 29 can dilute the mixture within the deionized water tank 140 below 2% hydrogen, but a flow rate of the portion of the oxygen product gas 29 into the deionized water tank 140 must be increased to ensure the mixture remains below 2% hydrogen.

As shown in FIG. 3A, the portion of the oxygen product gas 29 (i.e., the diluent 30) is injected into the deionized water tank 140 from the oxygen gas input 122. The degassed hydrogen gas of the mixture formed in the deionized water tank 140 is vented from the deionized water tank 140 via a vent 128.

The hydrogen management system 135 is configured to control operation of the electrolysis system 110 such that the portion of the oxygen product gas 29 can be used as the diluent 30 in the deionized water tank 140. The control system 134 of the hydrogen management system 135 receives HTO data from the HTO sensor 118, for example HTO measurements. Based on the HTO data, the control system 134 determines a status (e.g., a health, such as whether an amount of hydrogen (e.g., an HTO) in the oxygen product gas 29 exceeds a desired threshold, as discussed below in more detail) of the cell(s) 180 and the stack 111, 112 including the cell(s) 180. Based, at least in part, on the status of the cell 180 and the stack 111, 112, the control system 134 adjusts operation of the electrolysis system 110.

Equation 1 approximates the behavior of the electrolysis system 110. Other curves and/or equations may be used if the behavior versus load is different for that electrolysis system. The HTO is proportional to a production load for a given net hydrogen migration, which is represented by Equation 1

$$HTO * Load = {HTO}_{ref} * {Load}_{ref} \qquad ( 1 )$$

A standard HTO value (HTO_{ref}) is calculated using the HTO data measured by the HTO sensor 118 (HTO), the load fraction of the cell 180 and/or the stack 111, 112 at the time of measurement of the HTO (Load), and a reference load fraction (Load_{ref}). In some embodiments, Load_{ref} is set to 10%, which is the minimum production load of the cell 180. The minimum production load is the lowest load or current density at which the cell 180 can be safely operated.

In some embodiments, the electrolysis system 110 includes at least one current sensor 117 arranged near the cell 180 and/or the stack 111, 112, as shown in FIG. 1B. The current sensor 117 calculates and/or determines an operating current density of the cell 180 and/or the stack 111, 112 (i.e., the load fraction, Load). The control system 134 receives load and/or current data from the current sensor 117 and/or the stack 111, 112. In some embodiments, a load demand as received by the control system 134 is used as the load fraction (Load).

HTO_{ref} is calculated via Equation 1 to determine if an excess amount of hydrogen gas is crossing over the electrolyte 181E of the cell 180. The calculated HTO_{ref} is then compared to threshold values to determine the status/health of the cell 180 and/or the stack 111, 112. The control system 134 then takes particular actions based on the status/health. Exemplary comparisons of the calculated HTO_{ref} to threshold values are shown in Table 1. Exemplary threshold values are shown in Table 2.

TABLE 1

| Comparator | Status |
|---|---|
| HTO_{ref} < thv0 | Healthy |
| thv0 < HTO_{ref} < thv1 | Warning |
| thv1 < HTO_{ref} < thv2 | Unhealthy, Limit operating range |
| thv2 < HTO_{ref} | Unhealthy, Shut down |

TABLE 2

| Threshold | Value of HTO Threshold |
|---|---|
| thv0 | 0.75% |
| thv1 | 1.50% |
| thv2 | 7.50% |

If HTO_{ref} is less than a zero threshold value (i.e., thv0), then the cell 180 and/or the stack 111, 112 is healthy and operation of the electrolysis system 110 proceeds as usual. The zero threshold value is indicative of the HTO being relatively low (for example, below 0.75% hydrogen in the portion of the oxygen product gas 29, i.e., the diluent 30). When the HTO_{ref} is less than the zero threshold value, the target hydrogen gas concentration of the mixture in the deionized water tank 140 can be met using the diluent 30. When the HTO_{ref} is less than the zero threshold value, the control system 134 operates the oxygen gas input 122 to inject and/or introduce the diluent 30 into the deionized water tank 140 to manage the hydrogen gas concentration within the deionized water tank 140. In some embodiments, the zero threshold value is omitted and not used by the control system 134.

If HTO_{ref} is greater than the zero threshold value and less than a first threshold value (i.e., thv1), then the electrolysis system 110 operation proceeds as usual and a warning is output and issued to an operator. In embodiments in which the zero threshold value is omitted, if HTO_{ref} is less than the first threshold value, then the electrolysis system 110 operation proceeds as usual. In such an embodiment, the warning is not output and issued to the operator. When the HTO_{ref} is between the zero and first threshold values, the target hydrogen gas concentration of the mixture in the deionized water tank 140 can be met using the diluent 30.

When the HTO_{ref} is between the zero and first threshold values, the control system 134 operates the oxygen gas input 122 to inject the diluent 30 into the deionized water tank 140 to manage the hydrogen gas concentration within the deionized water tank 140. A warning is also issued by the control system 134 to the operator indicating that the HTO is increasing. In this way, the operator can schedule a maintenance event or check operation of the stack 111, 112 during the next scheduled maintenance event.

If HTO_{ref} is greater than the first threshold value and less than a second threshold value (i.e., thv2), then the electrolysis system 110 operation is limited and a warning is output and issued to an operator. The operating range of the cell 180 and/or the stack 111, 112 is limited by the control system 134 when HTO_{ref} is between the first and second threshold values. When the HTO_{ref} is between the first and second threshold values, the target hydrogen gas concentration of the mixture in the deionized water tank 140 can be met using the diluent 30 only when the cell 180 and/or the stack 111, 112 is operated within a limited operating range.

For example, before, the cell 180 and/or the stack 111, 112 may have been operated down to about 10% load, and now, due to the increasing HTO_{ref}, the cell 180 and/or the stack 111, 112 is only operable down to about 20% load. As previously described, as production load is decreased, HTO increases. Thus, increasing the lower operating limit of the cell 180 and/or the stack 111, 112 ensures that the HTO does not continue to increase within the portion of the oxygen product gas 29 such that the portion of the oxygen product gas 29 cannot be used as the diluent 30.

When HTO_{ref} is between the first and second threshold values, the control system 134 operates the oxygen gas input 122 to inject the diluent 30 into the deionized water tank 140 to manage the hydrogen gas concentration within the deionized water tank 140. The lower operating limit of the cell 180 and/or the stack 111, 112 is increased by the control system 134 such that the cell 180 and/or the stack 111, 112 does not operate below the lower operating limit. A warning is also issued by the control system 134 to the operator indicating that the HTO is increasing.

If HTO_{ref} is greater than the second threshold value, then the electrolysis system 110 operation is shut down and a warning is output and issued to an operator. When HTO_{ref} is greater than the second threshold value, the target hydrogen gas concentration of the mixture in the deionized water tank 140 cannot be met using the diluent 30 because the HTO within the portion of the oxygen product gas 29 is too high. HTO_{ref} being greater than the second threshold value indicates that the electrolysis system 110 is unhealthy and the HTO is higher than expected.

As shown in FIG. 3B, a method 400 for using the hydrogen management system 135 and the control system 134 is provided. In step 402, HTO data is determined using, for example, the HTO sensor 118. In step 404, using the HTO data, the HTO_{ref} is determined by the control system 134. For example, HTO_{ref} is determined using Equation 1 above. The method 400 then proceeds to decision step 406.

In decision step 406, the control system 134 compares the HTO_{ref} to the zero threshold value, as described above. If HTO_{ref} is less than the zero threshold value (“yes”), then the method 400 proceeds to step 408 and operation of the electrolysis system 110 proceeds as usual. In step 408, the control system 134 operates the oxygen gas input 122 to inject and/or introduce the diluent 30 into the deionized water tank 140 to manage the hydrogen gas concentration within the deionized water tank 140. If HTO_{ref} is greater than the zero threshold value (“no”) at decision step 406, then the method 400 proceeds to decision step 410.

In decision step 410, the control system 134 compares the HTO_{ref} to the zero and first threshold values, as described above. If HTO_{ref} is greater than the zero threshold value and less than the first threshold value (“yes”), then the method 400 proceeds to step 412. In step 412, the control system 134 operates the oxygen gas input 122 to inject the diluent 30 into the deionized water tank 140 to manage the hydrogen gas concentration within the deionized water tank 140. Also, optionally, in step 412, the control system 134 outputs a warning to the operator indicating that the HTO is increasing. If HTO_{ref} is greater than the first threshold value (“no”) at decision step 410, then the method 400 proceeds to decision step 414.

In decision step 414, the control system 134 compares the HTO_{ref} to the second and first threshold values, as described above. If HTO_{ref} is greater than the first threshold value and less than the second threshold value (“yes”) at decision step 414, the method 400 proceeds to step 416. In step 416, the control system 134 limits the operating production load of the cell 180 and/or the stack 111, 112. Also in step 416, the control system 134 operates the oxygen gas input 122 to inject the diluent 30 into the deionized water tank 140 to manage the hydrogen gas concentration within the deionized water tank 140. Optionally in step 416, the control system 134 outputs a warning to the operator. If HTO_{ref} is greater than the second threshold value (“no”) at decision step 414, then the method 400 proceeds to decision step 418.

In decision step 418, the control system 134 compares the HTO_{ref} to the second threshold value, as described above. If HTO_{ref} is greater than the second threshold value (“yes”) at decision step 418, the method 400 proceeds to step 420. In step 420, the control system 134 shuts down the electrolysis system 110 operation and a warning is optionally output to the operator. Also in step 420, the control system 134 does not operate the oxygen gas input 122 to inject the diluent 30 into the deionized water tank 140.

The control system 134 adjusts the electrolysis system 110 operation based on the HTO data from the HTO sensor 118. For example, the control system 134 limits the operating range of the cell 180 and/or the stack 111, 112 when HTO_{ref} is between the first and second threshold values. As another example, the control system 134 shuts the electrolysis system 110 down if HTO_{ref} is greater than the second threshold value.

Based, at least in part, on the HTO data, the control system 134 adjusts a flow rate of the diluent 30 into the deionized water tank 140 via a valve 196 (e.g., a first valve if two or more valves are provided) of the hydrogen management system 135. The valve 196 is arranged between the oxygen gas input 122 and the deionized water tank 140 to control the flow rate of the diluent 30 into the deionized water tank 140, as shown in FIG. 3A. As an example, if HTO_{ref} is between the zero and first threshold values, the control system 134 increases the flow rate because more of the diluent 30 is required to manage the hydrogen concentration in the deionized water tank 140 (as compared to if HTO_{ref} is less than the zero threshold value).

In some embodiments, the hydrogen management system 135 includes an optional second diluent input 126 configured to inject an optional second diluent 37 into the deionized water tank 140 through an optional second valve 198, as shown in FIG. 3A. The control system 134 controls operation of the valve 198 to open, close, and/or partially open the valve 198 to control a flow rate of the second diluent 37 through the valve 198. The second diluent 37 can be injected into the deionized water tank 140 in addition to the (first) diluent 30. For example, the second diluent 37 is injected into the deionized water tank 140 via the control system 134 when the portion of the oxygen product gas 29 (i.e., the diluent 30) is not sufficient to dilute the hydrogen gas concentration of the mixture in the deionized water tank 140.

As another example, the control system 134 operates the electrolysis system 110 to inject both of the diluent 30 and the second diluent 37, such as when HTO_{ref} is between the first and second threshold values and/or when HTO_{ref} is between the zero and first threshold values. In some embodiments, the second diluent 37 is nitrogen. In some embodiments, the second diluent 37 is air, such as ambient or external air. In some embodiments, the second diluent 37 is oxygen, for example, oxygen different than the oxygen product gas 29. In some embodiments, the second diluent 37 is any suitable diluent.

In some embodiments, the control system 134 uses Equation 1 to calculate a minimum operating production load (Load_{ref}). The minimum operating production load (Load_{ref}) is calculated using the HTO data by the HTO sensor 118 (HTO), the load fraction of the cell 180 and/or the stack 111, 112 at the time of measurement of the HTO data (Load), and a reference HTO (HTO_{ref}). In some embodiments, HTO_{ref} is set to 0.60%, which is the maximum HTO at any operating load to ensure that the target hydrogen gas concentration in the deionized water tank 140 can be met.

If the cell 180 and/or the stack 111, 112 is operated below the minimum operating production load (Load_{ref}), the HTO increases. Thus, operating the cell 180 and/or the stack 111, 112 at or above the calculated minimum operating production load (Load_{ref}) manages the HTO in the portion of the oxygen product gas 29 to ensure that the portion of the oxygen product gas 29 can be used as the diluent 30.

After the control system 134 calculates the minimum operating production load (Load_{ref}), the control system 134 operates the cell 180 and/or the stack 111, 112 such that the cell 180 and/or the stack 111, 112 does not operate below the minimum operating production load (Load_{ref}) unless the cell 180 and/or the stack 111, 112 is shutting down. If the cell 180 and/or the stack 111, 112 does operate at or below the minimum operating production load (Load_{ref}), the control system 134 operates the second diluent input 126 and the valve 198 such that the second diluent 37 is also injected into the deionized water tank 140.

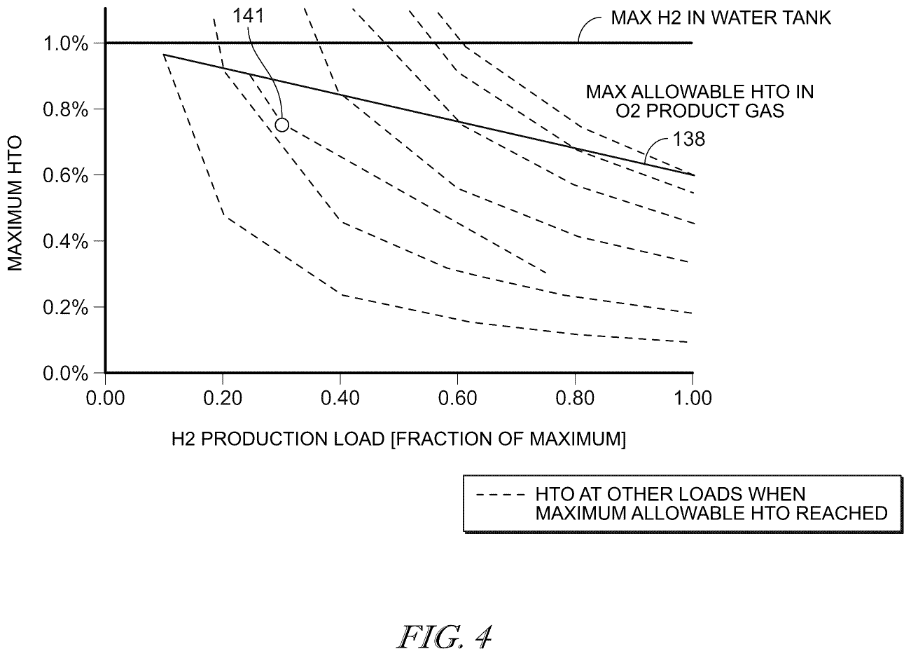

In some embodiments, the minimum operating production load is determined by the control system 134 based on the maximum allowable HTO in the portion of the oxygen product gas 29 being used as the diluent 30. As shown in FIG. 4, the maximum allowable HTO in the portion of the oxygen product gas 29 decreases as the production load increases. This is due to the increased degassing of the hydrogen gas in the deionized water tank 140 at higher production loads, as previously described. The maximum allowable HTO versus operating load is approximated by a linear relationship as shown by a line 138 in FIG. 4.

In some embodiments, the line 138 is derived using a mass balance around gas in the deionized water tank 140. The line 138 accounts for the change in hydrogen gas degassing versus load, and also assumes there is a maximum oxygen gas flow rate allowed into the deionized water tank 140 as the flow rate may be limited by various system designs, such as valve size, for example.

The dashed lines of FIG. 4 (HTO at other loads when maximum allowable HTO reached) are derived from Equation 1 above using electrolysis systems 110 having different behaviors. The dashed lines represent how the HTO varies with load.

HTO of the portion of the oxygen product gas 29 is measured at a given operating condition/load to determine the minimum operating production load. Specifically, the operating load and the measured HTO are used to place a measured point 141 on the graph of FIG. 4. The measured point 141 will overlap with a point on one of the dashed lines. In other words, a dashed line will pass through the measured point 141 that follows the same HTO versus load relationship.

The intersection of the HTO versus production load dashed line and the line 138 is used to determine the minimum operating production load. The minimum operating production load is the point of intersection between the dashed line (that passes through the measured point 141) and the line 138. The operating production load of the cell 180 and/or the stack 111, 112 should not be decreased to be below that minimum operating production load. The minimum operating production load is related to the maximum HTO such that operating below the minimum operating production load would result in too much hydrogen gas in the portion of the oxygen product gas 29. The control system 134 then operates the cell 180 and/or the stack 111, 112 at or above the minimum operating production load.

In some embodiments, the control system 134 includes a computing device 142 in communication over a network 150 with other components of the control system 134 including, but not limited to, a controller 156, one or more power sources 158 in the electrolysis system 110, and other components 162 of the electrolysis system 110 that determine function and performance.

The computing device 142 may be embodied as any type of computation or computer device capable of performing the functions described herein, including, but not limited to, a server (e.g., stand-alone, rack-mounted, blade, etc.), a network appliance (e.g., physical or virtual), a high-performance computing device, a web appliance, a distributed computing system, a computer, a processor-based system, a multiprocessor system, a smartphone, a tablet computer, a laptop computer, a notebook computer, and a mobile computing device.

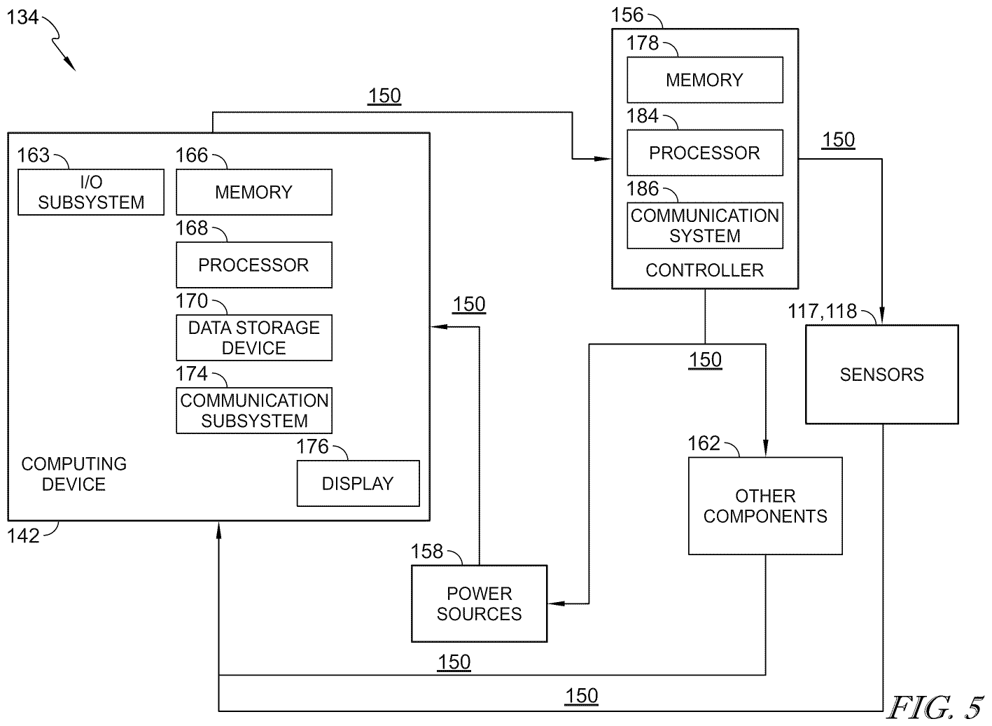

The illustrative computing device 142 of FIG. 5 may include one or more of an input/output (I/O) subsystem 163, a memory 166, a processor 168, a data storage device 170, a communication subsystem 174, and a display 176 that may be connected to each other, in communication with each other, and/or configured to be connected and/or in communication with each other through wired, wireless, and/or power line connections and associated protocols (e.g., Ethernet, InfiniBand®, Bluetooth®, Wi-Fi®, WiMAX, 3G, 4G LTE, 5G, etc.).

The computing device 142 may also include additional and/or alternative components, such as those commonly found in a computer (e.g., various input/output devices). In other embodiments, one or more of the illustrative computing device 142 of components may be incorporated in, or otherwise form a portion of, another component. For example, the memory 166, or portions thereof, may be incorporated in the processor 168.

The processor 168 may be embodied as any type of computational processing tool or equipment capable of performing the functions described herein. For example, the processor 168 may be embodied as a single or multi-core processor(s), digital signal processor, microcontroller, or other processor, or processing/controlling circuit. The memory 166 may be embodied as any type of volatile or non-volatile memory or data storage capable of performing the functions described herein.

In operation, the memory 166 may store various data and software used during operation of the computing device 142 such as operating systems, applications, programs, libraries, and drivers. The memory 166 is communicatively coupled to the processor 168 via the I/O subsystem 163, which may be embodied as circuitry and/or components to facilitate input/output operations with the processor 168, the memory 166, and other components of the computing device 142.

For example, the I/O subsystem 163 may be embodied as, or otherwise include, memory controller hubs, input/output control hubs, sensor hubs, host controllers, firmware devices, communication links (i.e., point-to-point links, bus links, wires, cables, light guides, printed circuit board traces, etc.) and/or other components and subsystems to facilitate the input/output operations.

In one embodiment, the memory 166 may be directly coupled to the processor 168, for example, via an integrated memory controller hub. Additionally, in some embodiments, the I/O subsystem 163 may form a portion of a system-on-a-chip (SoC) and be incorporated, along with the processor 168, the memory 166, and/or other components of the computing device 142, on a single integrated circuit chip (not shown).

The data storage device 170 may be embodied as any type of device or devices configured for short-term or long-term storage of data such as, for example, memory devices and circuits, memory cards, hard disk drives, solid-state drives, or other data storage devices. The computing device 142 also includes the communication subsystem 174, which may be embodied as any communication circuit, device, or collection thereof, capable of enabling communications between the computing device 142 and other remote devices over the network 150.

The components of the communication subsystem 174 may be configured to use any one or more communication technologies (e.g., wired, wireless and/or power line communications) and associated protocols (e.g., Ethernet, InfiniBand®, Bluetooth®, Wi-Fi®, WiMAX, 3G, 4G LTE, 5G, etc.) to effect such communication among and between system components and devices. The controller 156, the power sources 158, the computing device 142, and additional features or components 162 of the electrolysis system 110 may be connected, communicate with each other, and/or configured to be connected or in communication with each over the network 150 using one or more communication technologies (e.g., wired, wireless and/or power line communications) and associated protocols (e.g., Ethernet, InfiniBand®, Bluetooth®, Wi-Fi®, WiMAX, 3G, 4G LTE, 5G, etc.).

The computing device 142 may also include any number of additional input/output devices, interface devices, hardware accelerators, and/or other peripheral devices. The computing device 142 of the control system 134 of the electrolysis system 110 may be configured into separate subsystems for managing data and coordinating communications throughout the electrolysis system 110.

The display 176 of the computing device 142 may be embodied as any type of display capable of displaying digital and/or electronic information, such as a liquid crystal display (LCD), a light emitting diode (LED), a plasma display, a cathode ray tube (CRT), or other type of display device. In some embodiments, the display 176 may be coupled to or otherwise include a touch screen or other input device.

In one embodiment, the operations of the control system 134 are generated by the processor 168 based on several inputs, and applied or implemented by the controller 156 to affect the functioning of the electrolysis system 110. The inputs are provided by the current sensor 117 and/or the HTO sensor 118. In one embodiment, the operations of the control system 134 are generated by the processor 168 based on several inputs, and applied or implemented by the controller 156 in real time and/or automatically to affect the functioning of the electrolysis system 110. In one embodiment, the controller 156 is in the same computing device 142. In other embodiments, the controller 156 may include a memory 178, a processor 184, and/or a communication system 186, as previously described.

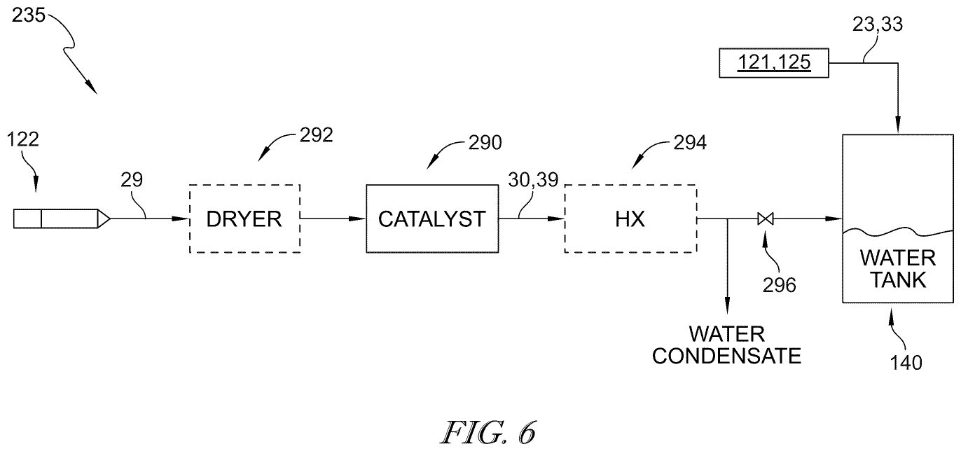

The present disclosure provides another hydrogen management system 235, as shown in FIG. 6, for use with the electrolysis system 110. The hydrogen management system 235 includes a catalyst 290. The catalyst 290 is arranged between the oxygen gas input 122 and the deionized water tank 140. To manage and/or decrease the HTO in the portion of the oxygen product gas 29, the portion of the oxygen product gas 29 is directed through the catalyst 290. In the catalyst 290, the oxygen gas within the portion of the oxygen product gas 29 and the hydrogen gas within the portion of the oxygen product gas 29 react with one another to form water. The formation of the water removes a majority (if not all) of the hydrogen gas from the portion of the oxygen product gas 29 to form a purified oxygen product gas 39 such that the purified oxygen product gas 39 can be used as the diluent 30 for the deionized water tank 140.

In some embodiments, the hydrogen management system 235 includes a dryer 292, as shown in FIG. 6, configured to remove moisture from the portion of the oxygen product gas 29 before the portion of the oxygen product gas 29 is directed through the catalyst 290. In some embodiments, the dryer 292 is arranged upstream of the catalyst 290. In some embodiments, the dryer 292 is a desiccant.

The temperature of the portion of the oxygen product gas 29 entering the catalyst 290 ranges from about 10° C. to about 65° C., including any range or specific temperatures comprised therein, such as about 20° C. As the oxygen gas and the hydrogen gas react in the catalyst 290, the temperature of the portion of the oxygen product gas 29 increases. The change in temperature (ΔT) of the portion of the oxygen product gas 29 within the catalyst 290 ranges from about 75° C. to about 85° C., including any range or specific temperatures included therein, for each 1% of reacted hydrogen gas. For example, for 1% of reacted hydrogen gas, the ΔT of the portion of the oxygen product gas 29 is about 80° C., and for 1.5% of reacted hydrogen gas, the ΔT of the portion of the oxygen product gas 29 is about 120° C.

In some embodiments, the hydrogen management system 235 includes a heat exchanger 294 arranged between the catalyst 290 and the deionized water tank 140, as shown in FIG. 6. The heat exchanger 294 is configured to cool the purified oxygen product gas 39 (i.e., the diluent 30) after the increase in temperature in the catalyst 290. The heat exchanger 294 decreases the temperature of the purified oxygen product gas 39 to a relatively low temperature so that damage to components of the deionized water tank 140 by a relatively hot or warm purified oxygen product gas 39 is prevented and/or minimized.

For example, in some embodiments, the heat exchanger 296 decreases the temperature of the purified oxygen product gas 39 to about 40° C. to about 70° C., including any range or specific temperatures comprised therein, such that the purified oxygen product gas 39 can then be directed into the deionized water tank 140. As the temperature of the purified oxygen product gas 39 is lowered in the heat exchanger 294, water may condense out of the purified oxygen product gas 39, as shown in FIG. 6.

The hydrogen management system 235 includes at least one valve 296 downstream of the heat exchanger 294, as shown in FIG. 6. The valve 296 is adjusted to control a flow rate of the purified oxygen product gas 39 into the deionized water tank 140.

In some embodiments, the catalyst 290 includes platinum on aluminum oxide. In some embodiments, the catalyst 290 includes palladium on aluminum oxide.

In some embodiments, the hydrogen management system 235 includes parallel catalyst legs (not shown). One of the parallel catalyst legs is operational at a time, while the other of the parallel catalyst legs is being regenerated. In some embodiments, a portion of the oxygen product gas 29 bypasses the catalyst 290 and is recombined with the purified oxygen product gas 39 downstream of the catalyst 290. Such an embodiment helps to reduce the ΔT. In some embodiments, the hydrogen management system 235 is used in combination with the hydrogen management system 135. For example, the control system 134 of the hydrogen management system 135 is communicatively coupled with the valve 296 to control a flow rate of the purified oxygen product gas 39 into the deionized water tank 140.

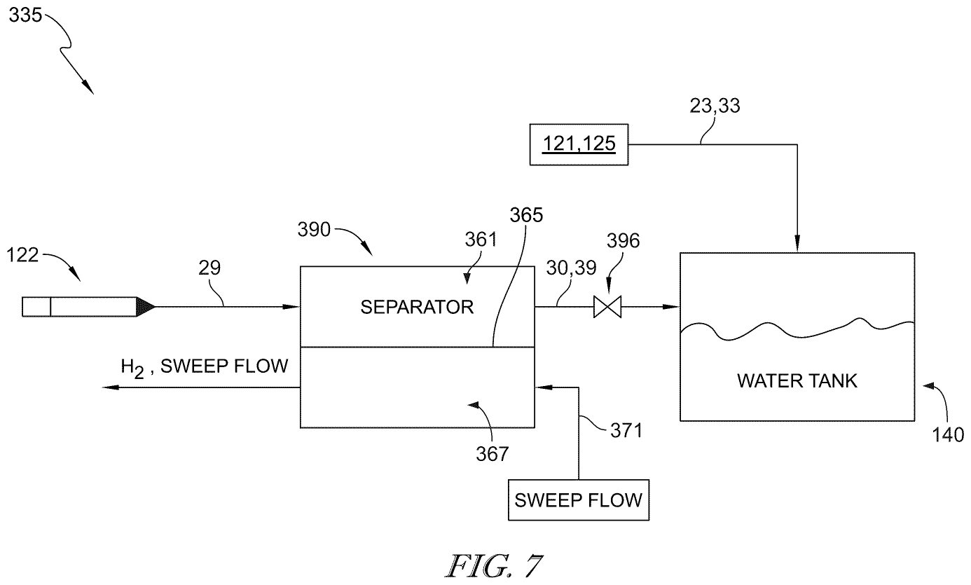

The present disclosure provides another hydrogen management system 335, as shown in FIG. 7, for use with the electrolysis system 110. The hydrogen management system 335 includes a gas membrane separator 390 configured to separate the oxygen gas and the hydrogen gas of the portion of the oxygen product gas 29. The gas membrane separator 390 is configured to reduce the hydrogen content in the portion of the oxygen product gas 29 to form a purified oxygen product gas 39 so that the purified oxygen product gas 39 can be used as the diluent 30 in the deionized water tank 140.

The portion of the oxygen product gas 29 is directed from the oxygen gas input 122 into the gas membrane separator 390, as shown in FIG. 7. As injected, the portion of the oxygen product gas 29 is located on a first side 361 of a membrane 365 of the gas membrane separator 390. The first side 361 of the membrane 365 may be referred to as a feed side 361 of the membrane 365. In some embodiments, a sweep flow 371 is directed through the gas membrane separator 390 on a second side 367 of the membrane 365 opposite the first side 361.

The second side 367 of the membrane 365 may be referred to as a sweep side 367 of the membrane 365. The hydrogen gas within the portion of the oxygen product gas 29 selectively diffuses across the membrane 365 from the feed side 361 to the sweep side 367 due to the partial pressures of the hydrogen gas and the oxygen gas. The hydrogen gas preferentially diffuses across the membrane 365 over the oxygen gas. The degree of diffusion depends on the relative concentrations of the hydrogen gas and the oxygen gas and the selectivity of the membrane 365. The hydrogen gas builds up on the sweep side 367 and is eliminated or reduced on the feed side 361 to create a purified oxygen product gas 39 to be directed into the deionized water tank 140.

Because the hydrogen gas is building up on the sweep side 367, the sweep flow 371 is injected into the sweep side 367 of the gas membrane separator 390 to maintain the hydrogen concentration on the sweep side 367 below a fraction of the lower flammability limit.

In some embodiments, the hydrogen management system 335 includes a valve 396 arranged between the gas membrane separator 390 and the deionized water tank 140, as shown in FIG. 7. The valve 396 is adjustable to control a flow rate of the purified oxygen product gas 39 (i.e., the diluent 30) into the deionized water tank 140.

The gas membrane separator 390 is designed to withstand high pressure differentials across the membrane 365. Preferably, the gas membrane separator 390 is designed to allow for about 5 bar to about 40 bar pressure differential across the membrane 365, including any range or specific pressure comprised therein, such as, for example, about 15 bar to about 30 bar. The gas membrane separator 390 being able to withstand high pressure differentials allows the gas membrane separator 390 to be smaller as the partial pressure driving force is proportionally higher.

As shown in FIG. 7, the gas membrane separator 390 is a counter-current (or counter-flow) gas membrane separator 390. In other words, the flow of the portion of the oxygen product gas 29 through the feed side 361 and the sweep flow 371 through the sweep side 367 are opposite one another. In some embodiments, the gas membrane separator 390 is a co-current gas membrane separator 390 such that the flow of the portion of the oxygen product gas 29 through the feed side 361 and the sweep flow 371 through the sweep side 367 are in the same direction as one another. In some embodiments, the gas membrane separator 390 is a cross-flow such that the flow of the portion of the oxygen product gas 29 through the feed side 361 and the sweep flow 371 through the sweep side 367 are tangential to one another.

In some embodiments, the sweep flow 371 includes air. In some embodiments, the sweep flow 371 includes nitrogen. In some embodiments, the sweep flow 371 includes oxygen.

As an example, without the hydrogen management system 335 and using an oxygen product gas 29 having 0.9% hydrogen as a diluent 30, 10 slpm of the oxygen product gas 29 is required to reduce the hydrogen concentration in the deionized water tank 140. With the hydrogen management system 335 and using an oxygen product gas 29 having 0.9% hydrogen as a diluent 30, 1.91 slpm of the purified oxygen gas product 39 is required to reduce the hydrogen concentration in the deionized water tank 140. Thus, greater diluent flow is required to reduce the hydrogen concentration within the deionized water tank 140 to below 1% hydrogen without use of the hydrogen management system 335.

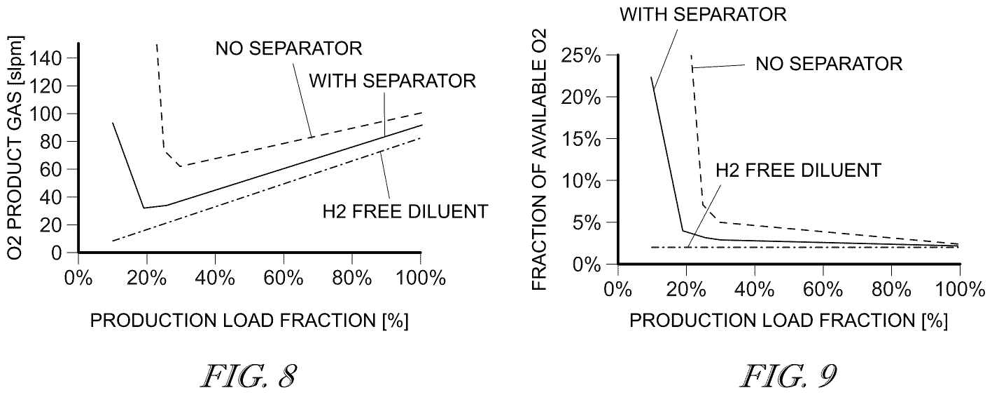

As shown in FIG. 8, the required diluent flow (in slpm) for an oxygen product gas free of hydrogen gas is proportional to production load. As shown in FIG. 9, the required diluent flow for an oxygen product gas free of hydrogen gas is a small fraction of the total available oxygen product gas (about 0% to about 5%).

Without the hydrogen management system 335, the minimum operating production load of the cell 180 and/or the stack 111, 112 is about 20% (as shown by the generally vertical portion of the line in FIG. 8). At these lower loads, there is insufficient oxygen product gas available to act as a diluent, as shown in FIG. 9.

With the hydrogen management system 335, the required diluent flow for the purified oxygen gas product 39 increases as the production load decreases below about 20%, as shown in FIG. 8. With the hydrogen management system 335, the minimum operating production load of the cell 180 and/or the stack 111, 112 can be decreased as compared to without the hydrogen management system 335. In other words, with the hydrogen management system 335, the operating range of the cell 180 and/or the stack 111, 112 is broadened to include lower minimum production loads as compared to without the hydrogen management system 335.

Full operation of the stack 111, 112 is maintained with the hydrogen management system 335. At a low load (around 10%), a greater amount of purified oxygen product gas 39 is required. However, the purified oxygen product gas 39 requirements approach those of the oxygen product gas free of hydrogen gas as the load increases, as shown in FIG. 8.

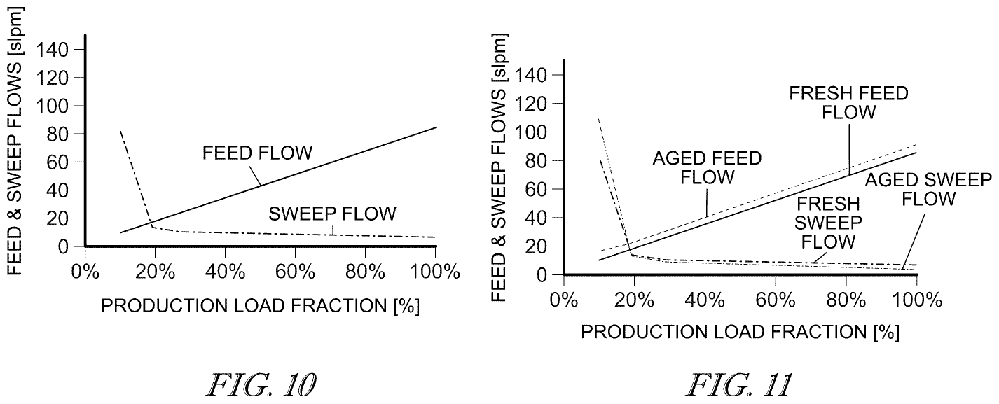

As shown in FIG. 10, at low production loads, an increase in the sweep flow 371 through the gas membrane separator 390 is required. As previously described, as the production load decreases, the HTO in the portion of the oxygen product gas 29 increases. As the HTO in the portion of the oxygen product gas 29 increases, more hydrogen gas will diffuse through the membrane 365 as the concentration of the hydrogen gas in the portion of the oxygen product gas 29 is higher.

Thus, in order to ensure that the hydrogen gas on the sweep side 367 stays below a fraction of the lower flammability limit, an increase in the sweep flow 371 is required to dilute the hydrogen gas on the sweep side 367. The feed flow (i.e., the portion of the oxygen product gas 29 flow) increases with an increase in production load, as shown in FIG. 10, because the amount of degassed hydrogen gas in the deionized water tank 140 increases as the production load increases.

In some embodiments, the hydrogen management system 335 is used in combination with the hydrogen management system 135. In some embodiments, the control system 134 of the hydrogen management system 135 is configured to control the feed flow (i.e., the portion of the oxygen product gas 29 flow) and the sweep flow 371. For example, in some embodiments, the control system 134 controls and/or adjusts a flow rate of the feed flow into the gas membrane separator 390, a flow rate of the sweep flow 371 into the gas membrane separator 390, and/or a flow rate of the purified oxygen product gas 39 out of the gas membrane separator 390 through the valve 396.

In some embodiments, based on the measured HTO by the HTO sensor 118, the control system 134 determines the required flow rates. In some embodiments, the feed flow and the sweep flow 371 are fixed throughout life of the electrolysis system 110. In some embodiments, the control system 134 monitors the health of the gas membrane separator 390 by measuring the concentration of hydrogen in the purified oxygen product gas 39 (via a hydrogen concentration sensor, for example). The control system 134 adjusts the feed and sweep flows 371 as needed based on the measured concentration. For example, the feed flow (i.e., the portion of the oxygen product gas 29 flow) increases as efficiency and selectivity of the membrane 365 degrades, as shown in FIG. 11.

As shown in FIG. 11, the feed flow increases as the gas membrane separator 390 ages and degrades. As the gas membrane separator 390 ages and degrades, the efficiency and selectivity of the membrane 365 decreases, meaning less hydrogen gas is separated from the oxygen gas such that more hydrogen gas is within the purified oxygen product gas 39 directed into the deionized water tank 140. As shown in FIG. 11, the sweep flow 371 decreases as the gas membrane separator 390 ages and degrades for production loads about 20% and higher.

As the selectivity of the membrane 365 decreases (e.g., the hydrogen gas diffusivity degrades faster than the oxygen gas diffusivity), more oxygen gas diffuses across the membrane 365 with the hydrogen gas. As such, less sweep flow 371 is required to dilute the hydrogen gas on the sweep side 367 to a safe, non-flammable concentration. However, in some embodiments, the oxygen gas diffusivity degrades faster than the hydrogen gas diffusivity, which causes more hydrogen gas to diffuse across the membrane 365 (not shown in graph of FIG. 11). In such an embodiments, more sweep flow 371 is required to dilute the hydrogen gas to a safe, non-flammable concentration on the sweep side 367.

The features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

The above embodiments are described in sufficient detail to enable those skilled in the art to practice what is claimed and it is to be understood that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” or “consists of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about,” and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. An electrolysis system, comprising:
an electrolyzer cell stack configured to use water and electricity to produce a hydrogen product gas and an oxygen product gas, wherein the oxygen product gas is configured to include crossover hydrogen gas;
a water tank arranged downstream of the electrolyzer cell stack and configured to receive:
a hydrogen tank stream including a first portion of water and dissolved or entrained hydrogen gas therein; and
an oxygen tank stream including a second portion of water and dissolved or entrained oxygen gas therein,
wherein, in the water tank, the dissolved or entrained hydrogen gas and the dissolved or entrained oxygen gas exsolve from the first and second portions of water to form a gas mixture; and
a hydrogen management system configured to control a concentration of the crossover hydrogen gas in at least a portion of the oxygen product gas to form a diluent for introduction into the water tank to decrease a hydrogen gas concentration in the gas mixture of the water tank to be at or below a threshold value.

2. The electrolysis system of claim 1, wherein the hydrogen management system includes a controller configured to determine a volume fraction of the crossover hydrogen gas in the at least a portion of the oxygen product gas, and based at least in part on the volume fraction of the crossover hydrogen gas in the at least a portion of the oxygen product gas, the control system is configured to determine a reference volume fraction.

3. The electrolysis system of claim 2, wherein, in response to the reference volume fraction being greater than a first threshold value, a minimum operating production load is set by the controller to control the concentration of the crossover hydrogen gas in the at least a portion of the oxygen product gas that forms the diluent and the controller is configured to operate the electrolyzer cell stack at or above the minimum operating production load.

4. The electrolysis system of claim 3, wherein, in response to the reference volume fraction being less than the first threshold value and greater than a zero threshold value, the diluent is introduced into the water tank at a first flow rate and the controller outputs a warning.

5. The electrolysis system of claim 4, wherein, in response to the reference volume fraction being less than the zero threshold value, the diluent is introduced into the water tank at a second flow rate.

6. The electrolysis system of claim 5, wherein the second flow rate is less than the first flow rate.

7. The electrolysis system of claim 3, wherein, in response to the reference volume fraction being greater than a second threshold value, the electrolyzer cell stack is shut down and the diluent is not introduced into the water tank, and wherein the second threshold value is greater than the first threshold value.

8. The electrolysis system of claim 1, wherein the diluent is a first diluent and the hydrogen management system further controls a second diluent different than the first diluent, such that the second diluent and the first diluent are both introduced into the water tank to decrease the hydrogen gas concentration in the gas mixture of the water tank.

9. The electrolysis system of claim 1, wherein the hydrogen management system includes a controller configured to determine a minimum operating production load of the electrolyzer cell stack, and wherein the controller operates the electrolyzer cell stack at or above the minimum operating production load to control the concentration of the crossover hydrogen gas in the at least a portion of the oxygen product stream that forms the diluent.

10. The electrolysis system of claim 1, wherein the hydrogen management system includes a catalyst arranged between the electrolyzer cell stack and the water tank, the catalyst is configured to remove at least a portion of the crossover hydrogen gas from the at least a portion of the oxygen product gas to decrease the concentration of the crossover hydrogen gas and form a purified oxygen product gas for introduction into the water tank as the diluent.

11. The electrolysis system of claim 10, wherein the hydrogen management system further includes a dryer arranged upstream of the catalyst and configured to remove moisture from the at least a portion of the oxygen product gas prior to the at least a portion of the oxygen product gas being exposed to the catalyst.

12. The electrolysis system of claim 10, wherein the hydrogen management system further includes a heat exchanger arranged downstream of the catalyst and configured to cool the purified oxygen product gas prior to introduction into the water tank.

13. The electrolysis system of claim 1, wherein the hydrogen management system includes a gas membrane separator having a membrane, the gas membrane separator is arranged between the electrolyzer cell stack and the water tank and is configured to receive the at least a portion of the oxygen product gas therein, and wherein the membrane is configured to diffuse the crossover hydrogen gas therethrough to decrease the concentration of the crossover hydrogen gas in the at least a portion of the oxygen product gas and form a purified oxygen product stream for introduction into the water tank as the diluent.

14. The electrolysis system of claim 13, wherein the membrane is configured to diffuse the crossover hydrogen gas therethrough to a sweep side of the gas membrane separator, and wherein a sweep fluid is directed through the sweep side to decrease a concentration of the crossover hydrogen gas on the sweep side.

15. A method of operating an electrolysis system, the method comprising:
producing a hydrogen product gas and an oxygen product gas by an electrolyzer cell stack, wherein the oxygen product gas is configured to include crossover hydrogen gas;
exsolving hydrogen gas and oxygen gas in a water tank located downstream of the electrolyzer cell stack to form a gas mixture;
managing a concentration of the crossover hydrogen gas in at least a portion of the oxygen product gas to form a diluent; and
injecting the diluent into the water tank to decrease a hydrogen gas concentration of the gas mixture in the water tank.

16. The method of claim 15, further comprising measuring a volume fraction of the crossover hydrogen gas in the oxygen product gas and determining, via a controller, a reference volume fraction based on the volume fraction.

17. The method of claim 16, further comprising comparing the reference volume fraction to a threshold value, and in response to the reference volume fraction being greater than the threshold value, setting a minimum operating production load of the electrolyzer cell stack via the controller such that the electrolyzer cell stack operates at or above the minimum operating production load.

18. The method of claim 17, further comprising, in response to the reference volume fraction being greater than a zero threshold value and less than the threshold value, outputting a warning and increasing a flow rate of the diluent into the water tank.

19. The method of claim 15, further comprising directing the at least a portion of the oxygen product gas into a catalyst arranged downstream of the electrolyzer cell stack to remove at least a portion of the crossover hydrogen gas from the at least a portion of the oxygen product gas to form the diluent.

20. The method of claim 15, further comprising directing the at least a portion of the oxygen product gas into a gas membrane separator arranged downstream of the electrolyzer cell stack to separate the crossover hydrogen gas from the at least a portion of the oxygen product gas to form the diluent.
